(19) United States
(12) Patent Application Publication
(10) Pub. No.: US 2005/0107107 A1
(43) Pub. Date: May 19, 2005

(54) Dynamic voice over data prioritization for wireless communication networks

(76) Inventors: Reza Shahidi, Stockholm (SE); Wanshi Chen, San Diego, CA (US); Seema Madan, San Diego, CA (US)

Correspondence Address: COATS & BENNETT, PLLC, P O BOX 5, RALEIGH, NC, 27602, US

(21) Appl. No.: 10/717,071

(22) Filed: Nov. 19, 2003

(51) Int. Cl. H04Q 7/20

(52) U.S. Cl. 455/522; 455/69

(57) ABSTRACT

A wireless communication network provides priority for one type of users over another type of users relative to one or more network finite resources shared by the different types of users. For example, if the available forward link transmit power at a radio base station is being shared by voice and data users, the radio base station may give priority to the voice users by reducing the aggregate amount of power allocated to current data users if the combined level of power usage by the voice and data users reaches a defined release threshold. The release threshold may be set at a call-blocking threshold, such that dynamic release is invoked if the call-blocking level is reached. Other limited resources can be managed similarly, such as by setting a release threshold relative to spreading code usage, etc.

### BACKGROUND OF THE INVENTION

The present invention generally relates to wireless communication networks, and particularly relates to prioritizing voice communication over data communication in such networks.

Many wireless communication networks, such as cdma2000, offer a wide variety of services, such as high quality voice, data, video, interactive applications, etc. Evolving wireless communication networks provide a range of packet-based data services, while simultaneously providing support for the more traditional circuit-switched services such as voice and fax data. In such networks, the radio base stations carry user traffic for both circuit-switched (voice) and packet-switched (data) users. Thus, voice and data users share the base station's limited resources, such as its available forward link transmit power and its pool of assignable CDMA spreading codes (e.g., the available Walsh codes).

Several issues arise in the context of base station resource sharing between voice and data users. For example, most data services are relatively delay insensitive and data traffic commonly is transmitted intermittently as needed, rather than continuously streamed. Contrastingly, voice services represent real-time services that require instantaneous transmission, and are relatively delay sensitive. Voice services also require a high-grade of service, such as a low call blocking rate, and a relatively low frame error rate (FER). Further, service providers typically garner larger revenues from voice services than from data services. As a result, there is an economic incentive for service providers to ensure that packet data services do not compromise the network's ability to offer high quality voice service.

Static voice-over-data prioritization is one solution meant to address the above sharing issues, and is adopted in at least some conventional wireless communication networks. Static prioritization of voice over data may be based on setting a higher call-blocking (admission) threshold for voice users than for data users with respect to a shared resource. For example, the blocking threshold for data users might be set at a first usage level (e.g., ninety percent), while the call-blocking threshold for voice users is set at a second, higher usage level (e.g., ninety-five percent). Similar schemes involve reserving a fixed amount of power for voice users, or involve using separate carriers, one for voice and one for data.

All such schemes tend to be inefficient because of the static nature of the prioritization schemes. That is, such schemes build in a preference for voice service that disadvantages data users even if the actual resource usage by voice users, or by the combination of voice and data users, is low.

### SUMMARY OF THE INVENTION

The present invention comprises a method and apparatus that provides dynamic voice-over-data prioritization by releasing resources from one or more data users if the combined voice and data usage of a shared resource reaches a defined release threshold. For example, where voice and data users share base station transmit power, a power release threshold can be set at a call blocking threshold and, if the power usage reaches that threshold, the base station can reduce the amount of power being used to serve selected ones of the data users so that a desired amount of currently allocated power is released. Such operation works dynamically to maintain the aggregate resource usage below a desired upper limit and thereby enhance resource availability for voice users.

Thus, in one embodiment, the present invention comprises a method of dynamically prioritizing voice service over data service in a wireless communication network providing voice and data service to one or more users. The method includes monitoring combined usage of a radio base station resource shared by current voice and data users relative to a resource release threshold and, if the combined usage meets or exceeds the resource release threshold, reducing the combined usage by modifying ongoing service to one or more of the current data users. The resource of interest may be forward link transmit power at a network radio base station, spreading codes, or another limited resource shared by voice and data users.

In an exemplary embodiment of the method, resources are released by a desired amount. For example, where the resource of interest is transmit power, the radio base station may be configured to reduce the overall power usage of the current data users by a specified amount, i.e., a defined Wattage value. The base station effects such release by modifying ongoing service to one or more data users. Such service modifications include, but are not limited to, reducing the transmit power on one or more data users' communication channels, changing radio configurations of one or more data users, or reducing the data rates being used to serve one or more data users. The base station may select which ones (and how many) of the data users to target based on fairness, throughput, or other criteria.

According to the present invention, an exemplary radio base station comprises transmitter circuits, one or more monitor circuits, and a release controller that initiates or otherwise controls dynamic resource release operations. The transmitter circuits transmit voice and packet data to current voice and data users according to one or more transmit parameters, such as transmit power, data rate, channel encoding rate, radio configuration, etc. An exemplary monitor circuit monitors the combined usage of one or more radio base station resources shared by the voice and data users, such as the combined transmit power. If the monitor circuit detects that the combined usage meets or exceeds a resource release threshold, the release controller selects one or more current data users for resource release and reduces the combined usage by modifying one or more transmit parameters, such as transmit power, corresponding to the selected current data users. Such operations may include or trigger complementary functions, such as commensurate reductions in data rates for the targeted data users.

Broadly, then, the present invention provides a method of prioritizing voice service over data service in a wireless communication network based on monitoring a combined usage of a network resource shared by current voice and data users and, if the combined usage exceeds a resource release threshold, reducing the combined usage a desired amount by modifying ongoing service to one or more of the current data users. Those skilled in the art will recognize that the present invention thus can be applied to essentially any finite resource where the usage of one type of user is to be prioritized over the usage of that resource by another type of user. Other features and advantages of the present invention will be apparent in light of the following description and the accompanying figures.

### BRIEF DESCRIPTION OF THE DRAWINGS

FIG. 1 is a diagram of an exemplary wireless communication network that is configured according to one or more embodiments of the present invention.

FIG. 2 is a diagram of exemplary sectorized radio base station coverage.

FIG. 3 is a diagram of exemplary functional details for a radio base station according to the present invention.

FIGS. 4A and 4B are diagrams of typical transmit power fluctuations over time and illustrate changing combined usage of base station transmit power by simultaneous voice and data users.

FIGS. 5A and 5B are diagrams of typical spreading code usage fluctuations over time and illustrate changing combined usage of spreading code resources by simultaneous voice and data users.

FIG. 6 is a diagram of exemplary processing logic according to an embodiment of the present invention.

FIG. 7 is a diagram of exemplary processing logic according to another embodiment of the present invention.

### DETAILED DESCRIPTION OF THE INVENTION

The following discussion describes the present invention in the context of cdma2000-based networks at various points. However, it should be understood that the present invention applies to any type of wireless communication network where different types of users, e.g., voice and data users, share one or more limited resources and it is desired to prioritize the use of those resources by one type of user relative to another type of user.

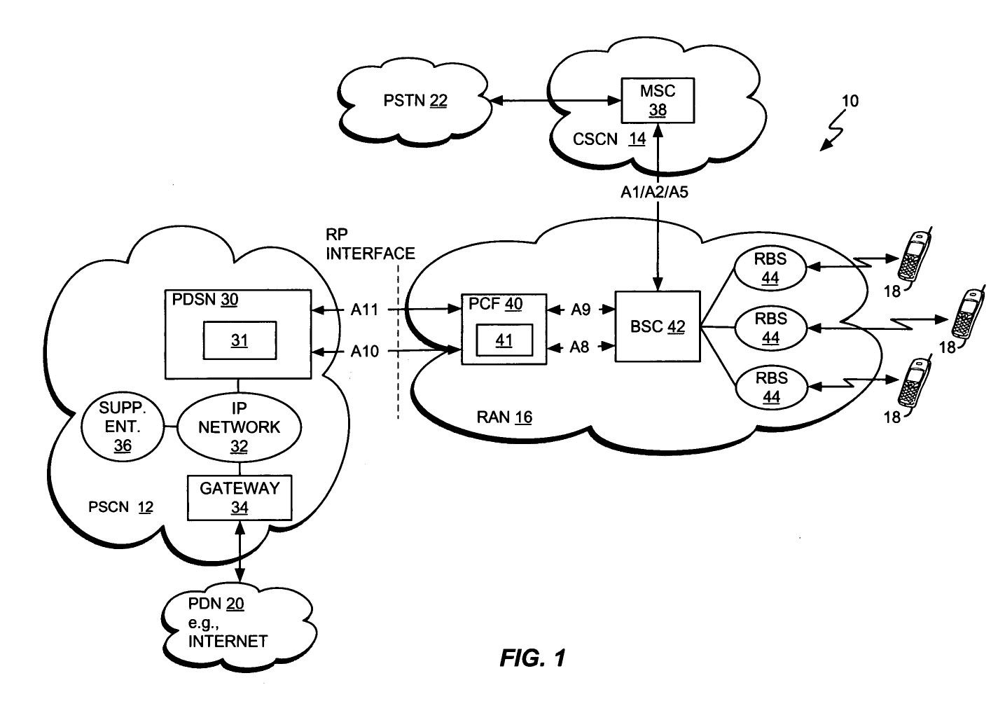

Turning to the drawings, FIG. 1 illustrates an exemplary wireless communication network 10 that is configured according to one or more embodiments of the present invention. Network 10 may comprise a cdma2000 wireless network according to the IS-2000/2001 families of standards. However, those skilled in the art will appreciate that the wireless communication network may be configured according to other standards, such as Wideband CDMA (WCDMA) standards, for example. Network 10 comprises a Packet-Switched Core Network (PSCN) 12, a Circuit-Switched Control Network (CSCN) 14, and a Radio Access Network (RAN) 16 that support communication between users of mobile stations (MSs) 18 and various external networks, such as one or more Public Data Networks (PDNs, e.g., the Internet) 20 and the Public Switched Telephone Network (PSTN) 22. The details of PSTN 22 and PDNs 20 are not material to the present invention, and therefore, are not discussed further herein.

Further, details of the core networks themselves are not particularly germane to the present invention but their illustration is helpful as a backdrop against the discussion of networks providing both voice and data services. Thus, an exemplary PSCN 12 supports packet data services and comprises a Packet Data Serving Node (PDSN) 30, an IP network 32, an optional gateway router 34, and one or more supporting entities 36 (authentication, foreign agent, etc.). An exemplary CSCN 14 supports voice and other circuit switched services and includes a Mobile Switching Center (MSC) 38, along with various other entities not illustrated for clarity of discussion (e.g., Home Location Register, Visitor Location Register, etc.).

The RAN 16 provides the radio interface between the mobile stations 18 and the various core networks, and an exemplary RAN 16 comprises a Packet Control Function (PCF) 40, a Base Station Controller (BSC) 42, and associated Radio Base Stations (RBSs) 44. BSC 42 connects to the MSC 38 via an A1/A2/A5 interface, to the PCF 40 via an A8/A9 interface, and to the RBSs 44 via an Abis interface. MSs 18 connect to RBSs 44 via the Um interface—i.e., the “air interface” as defined by the appropriate network standards, such as the IS-2000 family of standards.

The IS-2000 standard defines forward link fundamental channels (F-FCHs) that are used as dedicated forward link communication channels used to serve individual voice and data users. For example, a data user may be assigned a F-FCH to support packet data service to that user. If the data rate limits of the F-FCH are insufficient for the user's needs, one or more forward link supplemental channels (F-SCHs) may be assigned to the user. F-SCHs can be configured to support data rates that are multiples of the F-FCH data rate, and thus such channels are configured with 1×, 2×, 4×, and so on data rates.

Traffic between PSTN 22 and mobile stations 18 comprises circuit-switched traffic, such as voice or facsimile data, while traffic between PDN 20 and mobile stations 18 comprises packet-switched data traffic. (Note that an Inner-Working Function, IWF, might provide a communication link between the PSCN and CSCN core networks but such operation need not be explained in the context of the present discussion.) RBS 44 thus provides support to mobile stations 18 engaged in voice communications (referred to herein as voice users) and supports mobile stations 18 engaged in packet data communications (referred to herein as data users). Voice and data users share limited resources at RBS 44. These limited resources may include, but are not limited to, forward link transmit power and CDMA spreading codes, e.g., Walsh codes that are used to encode data for individual users.

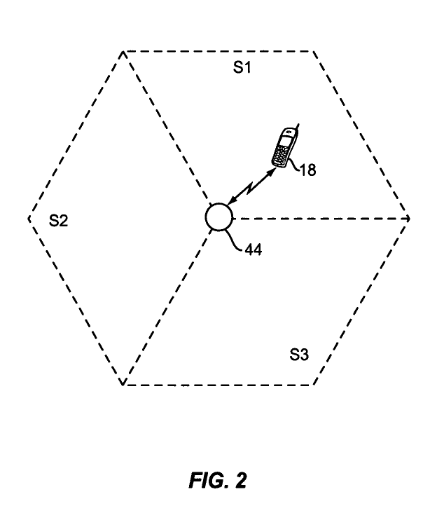

Each RBS 44 provides wireless coverage over one or more service areas or sectors, as shown in FIG. 2. In the context of the present invention, the shared resource(s) of interest may be shared by voice and data users at the sector level, or may be shared at the RBS level. While the RBS 44 shown in FIG. 2 provides coverage over three sectors, S1, S2, and S3, it will be understood by those skilled in the art that the wireless coverage area of RBS 44 may be divided into one or any number of sectors.

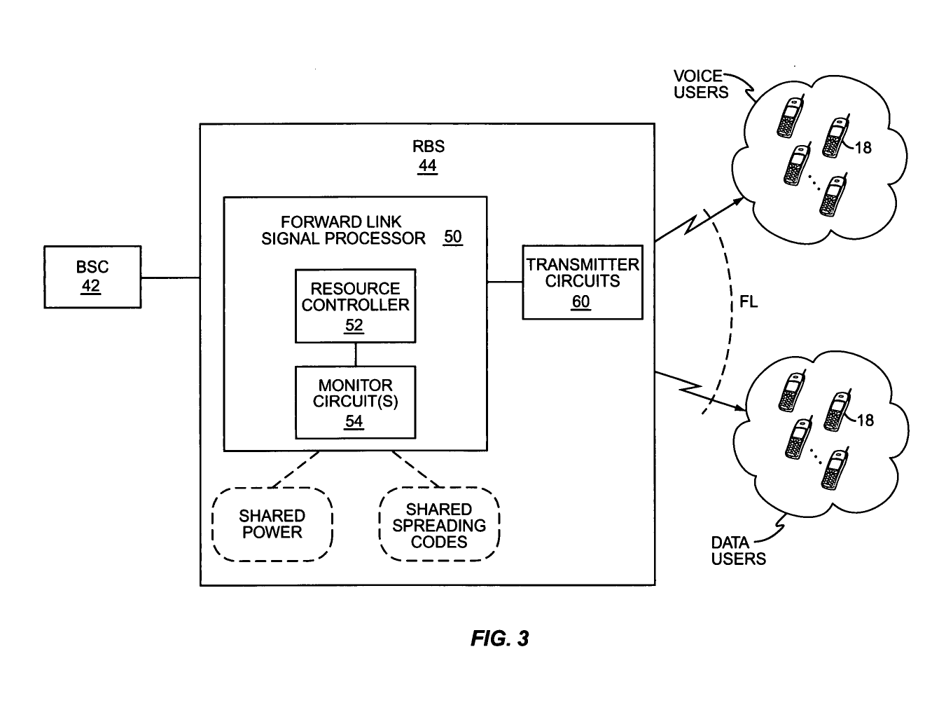

FIG. 3 illustrates a functional diagram of an exemplary RBS 44 according to one embodiment of the present invention. It will be appreciated that the present invention is not limited to the RBS architecture illustrated in FIG. 3, and that other RBS architectures are applicable to the present invention. Further, the functional elements of FIG. 3 may be implemented in software, hardware, or some combination of both. For example, one or more of the functional elements in RBS 44 may be implemented as stored program instructions executed by one or more microprocessors or other logic circuits included in RBS 44.

As shown in FIG. 3, RBS 44 includes forward link signal processor circuits 50 and associated transmitter circuits 60 (e.g., amplifiers, modulators, encoders, etc.). Circuits 50 process communication traffic incoming from the BSC for transmission to both voice and data users via transmitter circuits 60. According to the present invention, RBS 44 includes a release controller 52 and one or more associated monitor circuits 54. These elements may be implemented separately from or as part of processing circuits 50. In either case, the release controller 52 and monitor circuits 54 may be implemented in hardware, software, or some combination of both, and the monitor circuits 54 may be integrated with, or form part of, release controller 52. In an exemplary embodiment, the present invention comprises, at least in part, a computer program comprising stored program instructions that are executed by one or more microprocessors or other processing circuits within RBS 44.

As depicted in the illustration, RBS 44 supports communication services using one or more finite resources, e.g., a limited amount of forward link transmit power, or a limited number of forward link spreading codes. For example, if RBS 44 has a maximum of twenty Watts of forward link transmit power available for serving mobile stations 18 in a given sector, then the number of mobile stations 18 that it can simultaneously serve on the forward link is power-limited. Similarly, the exemplary RBS 44 may have at most sixty-four 64-length Walsh codes, where each code supports service to one individual mobile station if used as a short code (64-length), or can support service to two individual users if used as a long code (two 128-length codes can be derived from each 64-length code). Thus, to gain back (release) spreading codes, the RBS 44 may change one or more of the data users from using spreading codes in the base set of spreading codes (64-length codes) to using spreading codes in the extended set of spreading codes (128-length codes).

Monitor circuits 54 obtain, or are otherwise provided with, resource usage information for the shared resource(s) of interest. Such usage information can be in the form of current resource allocation levels, such as the current combined usage level of the resource by voice and data users, or can be in the form of remaining resource availability, e.g., the percentage or amount of the resource that is free for allocation. Thus, in an exemplary embodiment, the monitor circuits 54 may track the percentage or amount of transmit power and/or spreading codes used by the voice and data users currently being supported by the RBS 44.

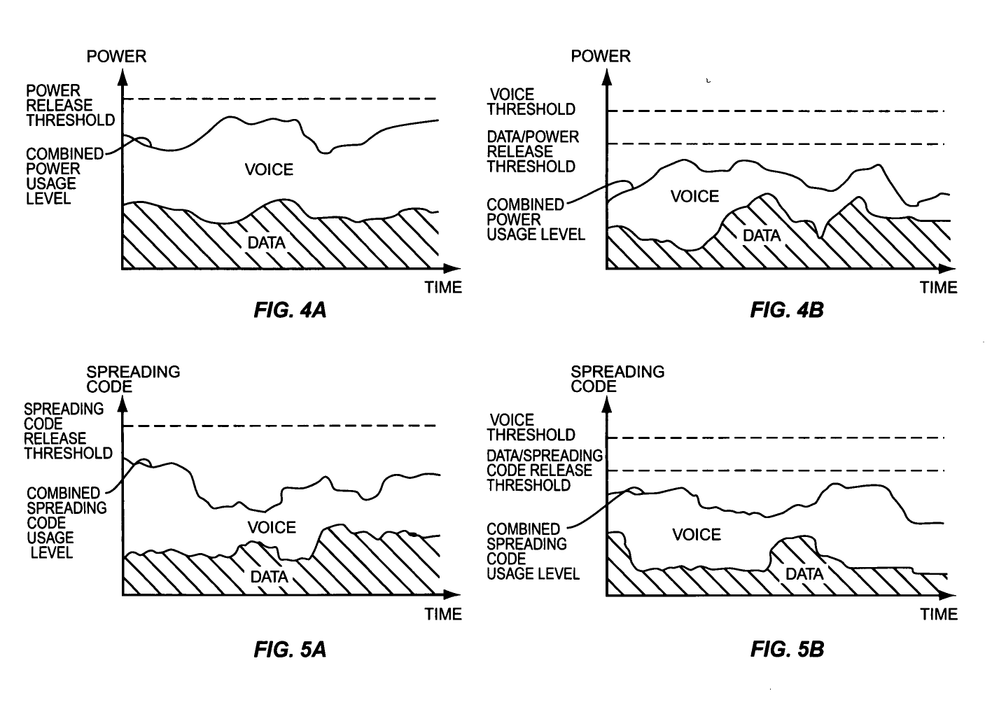

FIGS. 4A and 4B illustrate typical combined power usage levels for RBS 44, and illustrate that the total (combined) power required to service the aggregate of voice and data users on the forward link fluctuates over time with changing data requirements and with changing radio conditions for the individual users. Further, the portion of aggregate power used by the data users, and the portion used by the voice users fluctuate over time as well. Similarly, FIGS. 5A and 5B illustrate time varying allocation levels of spreading codes.

In particular, FIG. 4A illustrates monitoring a combined power usage relative to a release threshold, which may be set coincident to a data user call-blocking threshold. If the combined power usage reaches the defined release threshold, the RBS 44 dynamically releases (frees) a desired amount of forward link transmit power by altering its service to one or more of the current data users. In this manner, when the combined power usage rises to a level that will begin to compromise voice service to existing or new voice users, the RBS 44 releases some of the transmit power that currently is allocated to the existing data users.

FIG. 4B illustrates a similar approach, but here network 10 also uses a static prioritization method, wherein it defines a first call-blocking threshold for data users, and a second, higher call blocking threshold for voice users. In an exemplary embodiment, the release threshold of the present invention is set coincident with the lower, data-user blocking threshold, such that a desired amount of power is released from one or more data users responsive to the combined usage reaching the data user blocking threshold.

When monitoring the level of the combined transmit power usage, monitor circuits 54 may receive transmit power data corresponding to the combined transmit power of all voice and data forward link channels for comparison against the release threshold. Resource controller 52 may use an averaged usage level for comparison to the release threshold, such that a smoothed value is used for the comparison.

FIGS. 5A and 5B illustrate similar methods but in the context of spreading code resources. It should be noted that the present invention may include dynamic release of either or both spreading codes and transmit power, and that a release threshold can be defined for any shared resource of interest, and the appropriate release procedure invoked upon reaching that threshold. Those skilled in the art will appreciate that more than one resource may be monitored at a time, and that the exemplary resource release methods described herein can be applied to multiple resources simultaneously. For example, RBS 44 may monitor a power usage level against a power release threshold while simultaneously monitoring a spreading code usage level against a spreading code release threshold.

Regardless, if the combined usage of a shared resource of interest meets or exceeds a corresponding defined release threshold, release controller 52 dynamically releases a portion of that resource by modifying ongoing service to one or more of the current data users. In that sense, data users are penalized relative to voice users because the release controller 52 targets data users for resource release. More broadly, the release controller 52 can be configured to prioritize any type of user over any other type of user, such that if resources need to be freed, the non-priority users are targeted for such release.

When releasing resources, the release controller 52 determines the amount of resources to release, e.g., how much power should be freed, or how many spreading codes should be freed. In one embodiment, release controller 52 determines a target reduction amount by evaluating how far the combined usage is beyond the defined release threshold. In another embodiment, release controller 52 may use a predetermined target reduction amount to reduce the combined usage level by a set amount each time the combined usage level meets or exceed the release threshold. Such a value can be stored in memory in RBS 44, and may be a configuration value set by the network operator or service provider. In any case, the target reduction amount preferably reduces the combined current usage level by an amount sufficient to avoid “chatter” around the release threshold level. That is, the targeted release amount should be large enough to avoid immediate re-triggering of the release method.

In either case, the resource release may be performed in consideration of minimum required resource usage by the data users, for example. In other words, the release controller 52 may temper or otherwise constrain its operations to maintain a minimum usage level of the resource(s) by the data users. Such minimums may be configured by the network operator, or may be imposed by minimum data rate requirements, etc., such as minimum defined rates for the communication channels being used by the data users.

In any case, to reduce the combined usage by the target reduction amount, the release controller 52 may modify ongoing service to one or more data users, such as by modifying one or more transmit parameters corresponding to those users. For example, RBS 44 can reduce the amount of power allocated to one or more of the forward link communication channels being used to serve one or more of the current data users. Such a power reduction can be made directly by reducing the upper limits on transmit power to be used for the channel(s), e.g., by reducing the allowable power allocation for a channel from 5 Watts to 3 Watts, for example. Power reduction also can be made indirectly by initiating a data rate reduction on one or more data users' forward link communication channels. Other mechanisms for reducing a data user's forward link power allocation include, but are not limited to, changing the user's radio configuration, i.e., changing between RC3 and RC4 in an IS-2000 system, and/or changing channel encoding rates.

In an exemplary embodiment, the monitor circuits 54 track the average power used to transmit on individual forward link channels to one or more of the data users. To reduce the power to a particular data user, the RBS 44 changes the maximum allowed channel power for the user from its current setting to a value below the tracked average power. For example, in a cdma2000 network, the RBS 44 may effect power release by lowering the transmit power on one or more data users' forward link supplemental channels (F-SCH), which are rate-adjustable. Thus, RBS 44 may track the average supplemental channel powers for all or some of the data users and, if a power release is required, it will effect that release by reducing the maximum allowed transmit power for one or more of the F-SCHs to levels below the average transmit power tracked for those channels.

For example, assume that monitor circuits 54 determine that RBS 44 is transmitting on a particular data user's F-SCH at average power of 3 W but the channel has an upper (allowed) transmit power limit of 5 W. To reclaim power from this data user, release controller 52 may reduce the maximum transmit power allowed for the F-SCH from 5 W to 2 W, for example, resulting in a power release of about 1 W. This example is intended for illustrative purposes only, and it should be understood that essentially any method for reducing the transmit power known to those skilled in the art may be used in accordance with the present invention.

In another exemplary embodiment, release controller 52 may reduce the combined transmit power by changing a radio service configuration and/or by reducing the data rate of selected current data users, both of which relate to the transmit power. For example, release controller 52 may reduce the transmit power of one or more selected data users that currently are using 128-length Walsh codes by reassigning them to 64-length Walsh codes. Alternatively, because F-SCHs transmit data at incrementally higher data rates than F-FCHs, and therefore, at higher transmit powers, release controller 52 may impose rate reductions on one or more of those F-SCHs to gain a commensurate reduction in required forward link power.

It should be noted that, if spreading codes are the resource of interest, one or more of the above release methodologies also apply to code release operations. For example, changing radio conditions, e.g., changing from RC3 to RC4 or vice versa, changes spreading code usage by shifting the targeted data users from 64-length Walsh codes to 128-length Walsh codes, or vice versa. Use of 128-length Walsh codes expands the available code space and thus represents a net gain in available Walsh codes. Thus, release controller 52 can, at least to some extent, manipulate both power and spreading code usage levels by changing or modifying radio configurations, channel encoding rates, etc.

In targeting one or more of the current data users for resource release, the release controller 52 may be configured according to one or more overall service objectives. For example, release controller 52 may be configured according to a service “fairness” objective that avoids over penalizing any one of the current data users. Thus, rather than targeting one or a small number of data users for resource release, it targets a larger number such that a relatively small portion of the total resource amount to be released in the aggregate is taken from each one of them.

Conversely, release controller 52 may be configured to achieve a throughput objective (i.e., to optimize packet data throughput for the sector). With such a configuration, the release controller 52 may target the “worst” or most inefficient ones of the current data users for resource release, even if such targeting is not fair in terms of the average throughput to respective ones of the current data users. Such an approach essentially penalizes the data user(s) that currently are in the poorest radio conditions.

More generally, the release controller 52 can rank the current data users according to any desired criteria, such as an “efficiency metric,” and then select one or more of them as targets for resource release based on rank order. The criteria may comprise transmit power, data rate, a ratio of the transmit power to the data rate, or any other criteria that provides a performance or efficiency metric for ranking users. Once ranked, the release controller 52 selects as many data users as is required to achieve the targeted release amount.

In some embodiments, release controller 52 may place further constraints on the selection process described above. For example, one or more current data users may have service plans that include minimum rate guarantees or other service guarantees. Users with guaranteed data rates typically pay a premium to guarantee a predetermined minimum data rate for their packet data communications. Other data users may be engaged in particular applications or services that require minimum data rates, or that have other Quality of Service (QoS) constraints associated with them, such as minimum packet latencies, etc.

Release controller 52 may exclude data users having these or other service constraints associated with them from its resource release operations. Alternatively, it may consider such users as candidates for resource release operations but if so, it ensures that the resource release imposed on any particular data user does not violate any service constraints applicable to that user. Thus, release controller 52 can perform resource release operations while adhering to the mandates of users' service plans or QoS requirements by maintaining required minimum rates, latencies, etc. for the data users as needed.

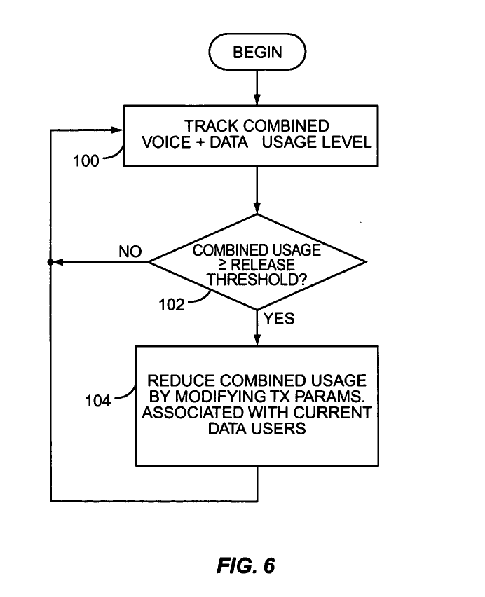

FIG. 6 illustrates a general method for implementing an exemplary embodiment of the present invention. As shown in FIG. 6, monitor circuits 54 track the combined voice and data usage level for a shared resource of interest (Step 100) and compare the combined usage level to a release threshold (Step 102). If the combined usage level is less than the release threshold, the monitor circuits 54 continue tracking the combined usage level. However, if the combined usage level meets or exceeds the release threshold, the release controller 52 reduces the combined usage by modifying service to one or more of the current data users (Step 104). As noted earlier, modifying service may comprise, but is not limited to, reducing transmit power, reducing or changing a channel encoding rate, changing radio configurations, changing channel data rates, etc. The monitor circuits 54 continue tracking the combined usage level to perform any subsequently required resource releases.

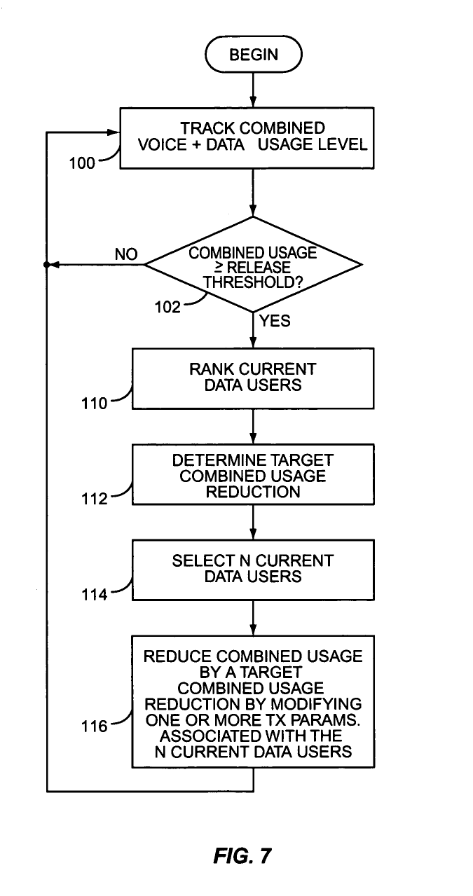

FIG. 7 illustrates another exemplary method of the present invention. As with FIG. 6, monitor circuits 54 track the combined voice and data usage level (Step 100) and compare the combined usage level to a release threshold (Step 102). If the combined usage level is less than the release threshold, then monitor circuits 54 continue to track the combined usage level (Step 100). However, if the combined usage level meets or exceeds the release threshold, then release controller 52 ranks the current data users according to desired criteria (Step 110). Release controller 52 determines a target usage reduction amount (Step 112) and then selects one or more current data users in rank order from which to release resources in an aggregate amount equal to the targeted (desired) amount of reduction.

Thus, the present invention provides dynamic prioritization for one type of user over another. In an exemplary embodiment, the present invention dynamically releases allocated resources from one or more selected data users, such that usage of a resource shared between voice and data users is maintained below a defined level. That level may be associated with call blocking, i.e., user admission/congestion control threshold. In doing so, the present invention releases power and/or code resources if the level of resource usage would otherwise result in voice users being blocked from admission into the network. In such contexts, the present invention provides a dynamic voice-over-data user prioritization scheme. Dynamic prioritization can be used alone, such as where the network uses a common blocking threshold for both voice and data users, or in combination with a static prioritization scheme, where the network uses different blocking thresholds for voice and data users.

More generally, the present invention comprises a method and apparatus for dynamic resource release. As such the present invention is not limited by the foregoing discussion of its exemplary details. Rather, the present invention is limited only by the following claims and their reasonable equivalents.

1. A method of prioritizing voice service over data service in a wireless communication network, the method comprising:
monitoring a combined usage of a shared network resource by current voice and data users; and
if the combined usage exceeds a resource release threshold, reducing the combined usage by a desired amount by modifying ongoing service to one or more of the current data users.

2. The method of claim 1, wherein monitoring a combined usage of a shared network resource by current voice and data users comprises monitoring usage of forward link transmit power at a network radio base station.

3. The method of claim 2, wherein reducing the combined usage a desired amount by modifying ongoing service to one or more of the current data users comprises reducing a transmit power allocation for one or more of the current data users.

4. The method of claim 3, wherein reducing a transmit power allocation for one or more of the current data users comprises reducing the transmit power of a forward link channel associated with each of the one or more current data users.

5. The method of claim 3, wherein reducing a transmit power allocation for one or more of the current data users comprises reducing a data rate of a forward link channel associated with each of the one or more current data users.

6. The method of claim 3, wherein reducing a transmit power allocation for one or more of the current data users comprises reducing an encoding rate of a forward link channel associated with each of the one or more current data users.

7. The method of claim 3, wherein reducing a transmit power allocation for one or more of the current data users comprises changing a radio service configuration of each of the one or more current data users.

8. The method of claim 3, further comprising selecting the one or more current data users for reduction of allocated transmit power based on ranking the current data users according to a forward link power-to-data-rate metric and choosing a number of current data users in rank order to achieve the desired amount of reduction.

9. The method of claim 1, further comprising choosing a particular one or more of the current data users for modification of ongoing service according to an overall service objective comprising either a fairness objective that prevents over-penalization of any of the current data users to maintain data service fairness, or a throughput objective that penalizes one or a small number of the current data users to maintain data service throughput.

10. The method of claim 1, wherein monitoring a combined usage of a shared network resource by current voice and data users comprises monitoring usage of forward link spreading codes at a network radio base station.

11. The method of claim 10, wherein reducing the combined usage a desired amount by modifying ongoing service to one or more of the current data users comprises reducing forward link spreading code usage for one or more of the current data users.

12. The method of claim 10, wherein reducing forward link spreading code usage for one or more of the current data users comprises changing a spreading code assignment for each of the one or more current data users from a spreading code in a base set of spreading codes to a spreading code in an extended set of spreading codes.

13. The method claim 1 wherein reducing the combined usage by a desired amount by modifying ongoing service to one or more of the current data users comprises reducing an aggregate usage of the shared network resource by the data users subject to one or more minimum usage constraints such that resources are not released from the current data users in violation of any minimum usage constraint.

14. A method of dynamically prioritizing voice service over data service in a wireless communication network, the method comprising:
monitoring combined usage of a radio base station resource shared by current voice users and data users relative to a resource release threshold; and
if the combined usage meets or exceeds the resource release threshold, reducing the combined usage by modifying service to one or more of the current data users.

15. The method of claim 14, wherein monitoring the combined usage of the radio base station resource shared by current voice and data users relative to the resource release threshold comprises monitoring the combined usage of a transmit power relative to a power release threshold.

16. The method of claim 15, wherein reducing the combined usage by modifying service to one or more of the current data users comprises reducing the transmit power corresponding to the selected ones of the current data users.

17. The method of claim 16, wherein reducing the transmit power corresponding to the selected ones of the current data users comprises changing an encoding rate of one or more forward link channels associated with the selected ones of the current data users.

18. The method of claim 16, wherein reducing the transmit power corresponding to the selected ones of the current data users comprises, for each selected data user, reducing a maximum allowed transmit power for the selected data user to a level below a current average transmit power being used to support the selected data user.

19. The method of claim 18, wherein reducing the maximum allowed transmit power further comprises reducing a data rate of each of the selected ones of the current data users in association with reducing the transmit powers.

20. The method of claim 16, wherein reducing the transmit power corresponding to the selected ones of the current data users comprises reducing a transmit data rate to each of the selected ones of the current data users.

21. The method of claim 14, further comprising conforming the modification of the one or more transmit parameters for the selected ones of the data users in accordance with any service constraints associated with those data users.

22. The method of claim 21, further comprising excluding any current data users that have one or more service constraints associated with them from consideration for selection as the selected ones of the current data users.

23. The method of claim 14, wherein monitoring combined usage of the radio base station resource shared by current voice and data users relative to the resource release threshold comprises monitoring combined usage of a set of spreading codes shared by current voice and data users relative to a spreading code usage threshold.

24. The method of claim 23, wherein reducing the combined usage by modifying one or more transmit parameters corresponding to selected ones of the current data users comprises changing a spreading code assignment for each of the selected ones of the current data users from a spreading code in a base set of spreading codes to a spreading code in an extended set of spreading codes.

25. The method of claim 14, further comprising selecting the selected ones of the current data users based on ranking them according to a predetermined criteria.

26. The method of claim 25, wherein selecting the selected ones of the current data users comprises selecting one or more of the current data users as targets for resource release based on a rank order of the current data users and a targeted aggregate reduction amount.

27. The method of claim 25, wherein ranking the current data users according to the predetermined criteria comprises ranking the current data users according to an amount of transmit power currently allocated to each of the current data users.

28. The method of claim 26, wherein ranking the current data users according to the predetermined criteria comprises ranking the current data users according to a data rate being used to serve each of the current data users.

29. The method of claim 26, wherein ranking the current data users according to the predetermined criteria comprises determining a transmit power to data rate ratio for each of the current data users and ranking the current data users according to the ratios.

30. The method of claim 14, wherein modifying one or more transmit parameters corresponding to selected ones of the current data users comprises modifying radio configurations of the selected ones.

31. A radio base station comprising:
transmitter circuits to transmit to voice and data users;
a monitoring circuit to monitor combined usage of a radio base station resource shared by current voice and data users relative to a resource release threshold; and
a release controller to reduce the combined usage by modifying one or more transmit parameters corresponding to selected ones of the current data users if the combined usage exceeds the resource release threshold.

32. The radio base station of claim 31, wherein the monitoring circuit is configured to monitor usage of forward link transmit power as the shared resource relative to a power usage level, and wherein the resource controller is configured to modify transmit power as one of the one or more transmit parameters.

33. The radio base station of claim 32, wherein the release controller is configured to reduce the combined usage of the forward link transmit power by reducing an aggregate amount of forward link transmit power allocated to the current data users.

34. The radio base station of claim 33, wherein the release controller is configured reduce the amount the aggregate amount of forward link transmit power allocated to the current data users by reducing transmit powers of one or more forward link communication channels being used to serve one or more of the current data users.

35. The radio base station of claim 34, wherein radio base station comprises a cdma2000 radio base station, and wherein the release controller is configured to reduce the transmit powers of one or more forward link communication channels being used to serve one or more of the current data users by reducing the transmit power of one or more forward link supplemental channels.

36. The radio base station of claim 35, wherein the release controller is configured to reduce the transmit power of one or more forward link supplemental channels by tracking an average power being used to transmit on each forward link supplemental channel targeted for reduction, and setting a maximum allowed power for the forward link supplemental channel to a level below that average power.

37. The radio base station of claim 35, wherein the release controller is configured to reduce the transmit power of one or more forward link supplemental channels by reducing data rates of the one or more forward link supplemental channels.

38. The radio base station of claim 33, wherein the release controller is configured to reduce the aggregate amount of forward link transmit power allocated to the current data users by reducing data rates on one or more forward link communication channels being used to serve the selected ones of the current data users.

39. The radio base station of claim 33, wherein the release controller is configured to reduce the aggregate amount of forward link transmit power allocated to the current data users by changing radio configurations of one or more of the current data users.

40. The radio base station of claim 31, wherein the monitoring circuit is configured to monitor usage of forward link spreading codes as the shared resource relative to a code allocation level.

41. The radio base station of claim 40, wherein the release controller is configured to reduce the allocation of forward link spreading codes by changing a spreading code assignment for one or more of the current data users from a base set of spreading codes to an extended set of spreading codes.

42. The radio base station of claim 31, wherein the reducing the combined usage by modifying service to one or more of the current data users comprises:
ranking at least a portion of the current data users according to a defined criteria; and
targeting one or more of the current data users based on rank order for modification of service to effect a desired amount of reduction.

43. The radio base station of claim 42, wherein the release controller is configured to perform ranking based on determining an efficiency metric associated with serving each current data user on the forward link.

44. The radio base station of claim 42, wherein the release controller is configured to determine the efficiency metric for each current data user based on a power-to-rate ratio of forward link transmit power to forward link data rate, such that the release controller preferentially targets current data users having higher power-to-rate ratios for modification of service.

45. The radio base station of claim 31, wherein the release controller is configured to release to reduce the combined usage by modifying one or more transmit parameters corresponding to selected ones of the current data users subject to one or more minimum usage constraints such that the resource release does not violate any minimum usage requirement associated with the current data users.
